(19) United States
(12) Patent Application Publication
(10) Pub. No.: US 2022/0051828 A1
(43) Pub. Date: Feb. 17, 2022

(54) TARGET TRANSPORT SYSTEM, TARGET BODY, AND TARGET TRANSPORT METHOD

(71) Applicant: Nihon Medi-Physics Co., Ltd., Koto-ku, Tokyo (JP)

(72) Inventor: Taku ITO, Koto-ku, Tokyo (JP)

(73) Assignee: Nihon Medi-Physics Co., Ltd., Koto-ku, Tokyo (JP)

(21) Appl. No.: 17/278,891

(22) PCT Filed: Sep. 6, 2019
(86) PCT No.: PCT/JP2019/035253

§ 371 Date: Mar. 23, 2021

(30) Foreign Application Priority Data
Sep. 25, 2018 (JP) 2018-179260

(51) Int. Cl. G21K 5/08; H05H 6/00

(52) U.S. Cl. CPC G21K 5/08; H05H 2242/10; H05H 6/00

(57) ABSTRACT

Provided is a target transport system which is advantageous in simplifying and downsizing a configuration in production of radio-isotopes using an accelerator and in which components are hardly affected to be damaged by radiation. The target transport system includes: a transport pipeline through which a target body is transported; a target holding part that holds the target body and allows the target body to be irradiated with particle beams; and a pump, the transport pipeline, and a target entry port that transport the target body to the target holding part by a cooling water. The pump, the transport pipeline, and the target entry port cause the cooling water to flow in the transport direction, and the target body is recovered from the transport pipeline by the cooling water.

### TECHNICAL FIELD

The present invention relates to a target transport system, a target body, and a target transport method for transporting a target for producing a radioactive nuclide.

### BACKGROUND ART

In the production of Radio Isotopes (hereinafter referred to as RI), particle beams such as p (proton), d (deuteron), a (helium nucleus), e (electron), and heavy ion are created using an accelerator, and the created particle beams are irradiated to the target material for nuclear reaction. As a result of the nuclear reaction, various radio isotopes (RIs) can be obtained from the target. Incidentally, as the target form, any of solid, liquid, and gas targets is used depending on a production purpose.

Since RIs exist in the vicinity of the target apparatus after particle beam irradiation, it is desirable to perform the work of taking out the target from the irradiation position of the particle beam in a shielded position. The production of RIs is carried out in a nuclear reactor or is carried out by an accelerator represented by a cyclotron. In both cases, the target is irradiated with particle beams in a space shielded by concrete or the like, and the target after irradiation is handled via a manipulator or the like in equipment such as a hot cell which protects an operator from radiation exposure.

When RIs are produced in the nuclear reactor, for example, Patent Document 1 describes that a solid sample is transported to an irradiation port by a fluid to be taken out. Further, it is described in Patent Document 2 that a solid target is recovered when RIs are produced by using a cyclotron.

The irradiation port of the nuclear reactor described in Patent Document 1 is for individually taking out a solid substance containing a plurality of samples called rabbits in the nuclear reactor. Further, the solid target recovery device of Patent Document 2 includes a guide member that guides the solid target after the nuclear reaction to a radiation shielding container and a vibration motor that vibrates the guide member. Then, in the configuration described in Patent Document 2, the solid target falling on the guide member is vibrated by the vibration motor to be guided to the radiation shielding container.

### CITATION LIST

### Patent Documents

Patent Document 1: JP 62-76499 A

Patent Document 2: JP 2008-268127 A

### SUMMARY OF THE INVENTION

### Problem to be Solved by the Invention

However, in an environment where nuclides are produced by using the accelerator, charged particles contained in the particle beam irradiated to the target lose energy in the target and generate a large amount of heat in a small volume target. The generated heat can melt a member which houses the target. For this reason, in an RI producing device which produces nuclides, it is essential to cool the target with helium gas or cooling water during irradiation with particle beams.

The above-described Patent Document 2 describes that a target part housing the target includes a through hole and a cooling water circulation hole connected to a vacuum pump. The solid target is fixed in the target part by pumping air out through the through hole.

As described above, in the configuration described in Patent Document 2, both a mechanism for circulating cooling water and a mechanism for holding and recovering the solid target are required respectively. However, it is preferable that the number of mechanisms provided in the device is small since it is advantageous in simplifying and downsizing the device and increasing the flexibility of the layout of the system. Further, in the configuration described in Patent Document 2, the motor is arranged near the guide member and, further, the solid target in order to transmit vibration to the guide member. As a result, a signal which is input to or output from the vibration motor may be affected by radiation, which may interfere with the operation of the vibration motor.

The present invention has been made in view of the above points, and relates to a target transport system, a target body, and a target body transport method which are advantageous in simplifying and downsizing a configuration in production of RIs using an accelerator and in which components are hardly affected to be damaged by radiation.

### Means for Solving the Problem

A target transport system according to the present invention includes: a transport pipeline through which a target body containing at least a source material body for producing a nuclide is transported; a target holding part that holds the target body and allows the target body to be irradiated with particle beams output from an accelerator; and a transport mechanism that transports the target body to the target holding part by a fluid flowing in the transport pipeline in a transport direction, wherein the transport mechanism causes the fluid to flow in the transport pipeline in the transport direction during irradiation with the particle beams in the target holding part, and the target body is recovered by the fluid from the transport pipeline after the irradiation with the particle beams is completed.

A target body according to the present invention is a target body used in the above target transport system. The target body includes: a first plate portion which is directed in an irradiation direction of particle beams; a second plate portion which is parallel to the first plate portion; and a source material body which is loosely inserted between the first plate portion and the second plate portion, wherein an interval between the first plate portion and the source material body is wider than an interval between the second plate portion and the source material body.

A target transport method according to the present invention includes: an introduction process of introducing a target body into a pipeline through which the target body containing at least a source material body for producing a nuclide is transported; a transport process of transporting the introduced target body by a fluid flowing in the pipeline to a target holding part where the target body is irradiated with particle beams output from an accelerator; a flow process of flowing the fluid in a transport direction of the target body during the irradiation of the target body with the particle beams in the target holding part; and a recovery process of recovering the target body from the target holding part through the pipeline by the fluid after the irradiation of the target body with the particle beams is completed.

### Effect of the Invention

The present invention can provide the target transport system, the target body, and the target body transport method which are advantageous in simplifying and downsizing a configuration in production of RIs using the accelerator and in which components are hardly affected to be damaged by radiation.

### BRIEF DESCRIPTION OF THE DRAWINGS

FIG. 1A is a diagram illustrating a known RI production system, and FIG. 1B is a diagram illustrating a transport system according to an embodiment of the present invention.

FIG. 2 is a diagram for explaining the entire target transport system according to the embodiment of the present invention.

FIG. 3 is a diagram for explaining a target holding part illustrated in FIG. 2, and is a front view of the target holding part.

FIG. 4 is a back view of the target holding part illustrated in FIG. 2.

FIG. 5 is a right side view of the target holding part illustrated in FIG. 3.

FIG. 6 is a cross-sectional view of the target holding part along a one dot chain line illustrated in FIG. 3.

FIG. 7 is a diagram for explaining a connection between a pipeline portion and a transport pipeline portion illustrated in FIG. 2.

FIG. 8 is a cross-sectional view of the target holding part along a one dot chain line illustrated in FIG. 5.

FIG. 9A is a cross-sectional view of an irradiation flange along a one dot chain line illustrated in FIG. 9B, and FIG. 9B is a partially enlarged view of FIG. 6.

FIG. 10 is a diagram for explaining the position of a target body during irradiation with particle beams.

### DESCRIPTION OF EMBODIMENTS

Hereinafter, an embodiment of the present invention will be described on the basis of the drawings. Incidentally, in all the drawings, the same components are denoted by the same reference numerals, and duplicate description thereof will not be repeated as appropriate. Further, in the drawings of this embodiment, the positional relationship, function, and shape of the configuration of the invention are given as an example, and the dimensional shape, length, width, and height thereof are not limited.

### Outline

First, an outline of this embodiment will be described prior to the specific description of this embodiment.

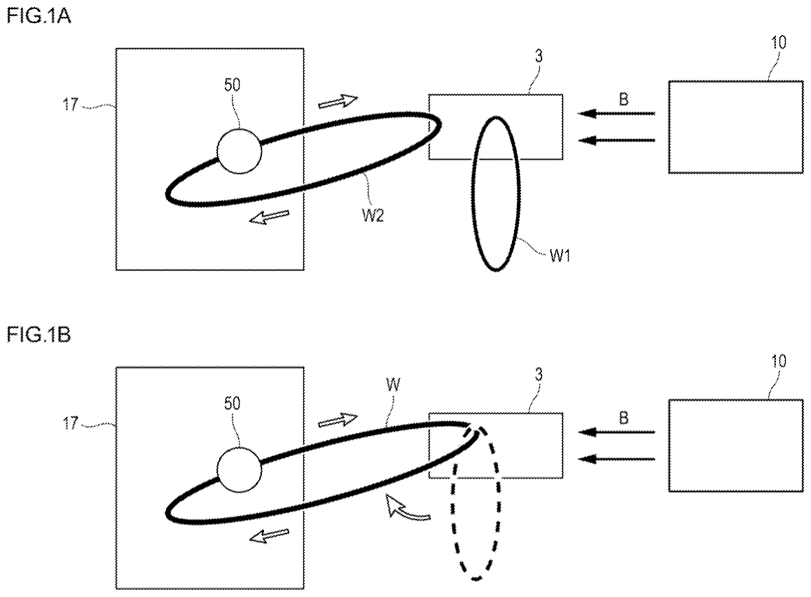

FIGS. 1A and 1B are diagrams for explaining the outline of this embodiment. FIG. 1A illustrates a known RI producing device, and FIG. 1B illustrates a RI producing device to which a transport system of this embodiment is applied. FIGS. 1A and 1B illustrate an accelerator 10, a transport mechanism 17, and a target holding part 3. The accelerator 10 is a device which accelerates charged particles by an electric field, and examples thereof include a cyclotron, a linear accelerator, and a synchrotron.

From the accelerator 10, high-speed charged particles are irradiated as particle beams B toward the target holding part 3. The target holding part 3 is a device which fixes the target body 50 at the irradiation position of the particle beams B such that the target body 50 is irradiated with the particle beams B. The transport mechanism 17 is a mechanism which transports the target body 50 to the irradiation position of the target holding part 3 and recovers the target body from the target holding part 3 after the irradiation is completed.

As described above, in the RI producing device, it is essential to cool the target with helium gas or cooling water during irradiation with particle beams. In the known RI producing device, as illustrated in FIG. 1A, the target body 50 is cooled by a cooling water W1 in the target holding part 3, and the transport mechanism 17 transports the target body 50 by using a water W2. In such an RI producing device, a mechanism for flowing the cooling water W1 and the water W2 will be separately provided.

On the other hand, in this embodiment, as illustrated in FIG. 1B, in the target holding part 3, both the cooling of the target body 50 and the transport by the transport mechanism 17 are performed by the cooling water W. In this embodiment, the transport and cooling of the RI producing device can be realized by using one mechanism, and the configuration of an RI device can be simplified and miniaturized. Further, in this embodiment, the target body 50 is transported by the cooling water W, and thus the transport of the target body 50 can be controlled by remote control without providing a mechanical or electronic component in the vicinity of an irradiation device or in the area shielded by a radiation shielding material.

### Target Transport System

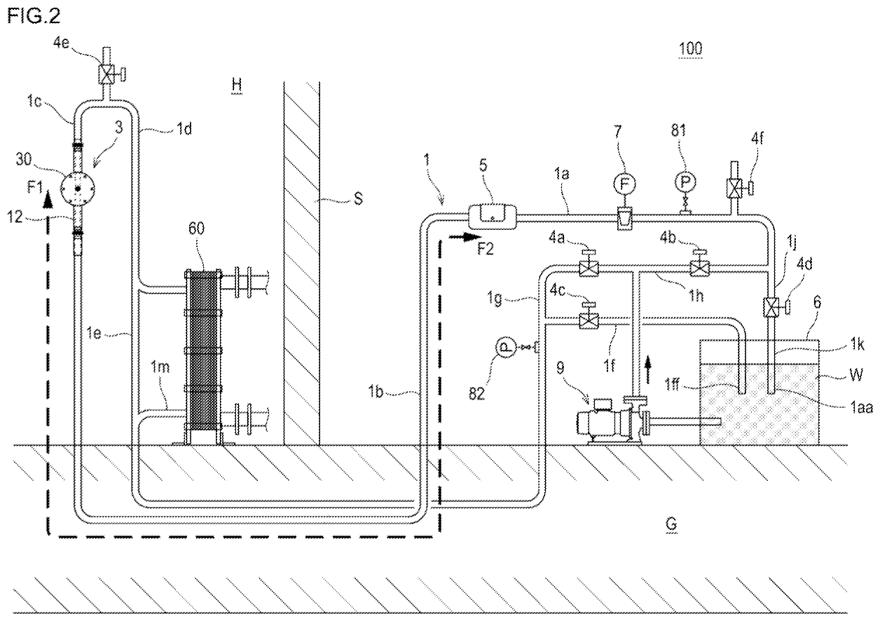

FIG. 2 is a diagram for explaining the entire target transport system of this embodiment. A target transport system 100 of this embodiment includes a transport pipeline 1 through which the target body 50 (FIG. 2 and the like) containing at least a source material body for producing nuclides is transported, the target holding part 3 which holds the target body 50 and in which the target body 50 is irradiated with particle beams output from the accelerator 10 (FIG. 1), and the transport mechanism 17 (FIG. 1B) which transports the target body 50 to the target holding part 3 by the cooling water W which is a fluid which flows in the transport pipeline 1 in a transport direction and cools the target body 50. The transport mechanism 17 causes the cooling water W to flow in the transport pipeline 1 in the transport direction of the target body 50 during the irradiation with the particle beams in the target holding part 3, and recovers the target body 50 from the transport pipeline 1 by the cooling water W after the irradiation with the particle beam is completed. As illustrated in FIG. 2, the target holding part 3 has an irradiation flange 30 in which the target body 50 is held to be irradiated with the particle beams B and an irradiation pipeline 12 which communicates with the irradiation flange 30 and the transport pipeline 1.

The transport mechanism 17 of this embodiment is configured by the transport pipeline 1, a target entry port 5, and a pump 9. Further, the “source material body” of this embodiment is a material made of a member for producing a nuclide, and may be any one of solid, powder, gas, or liquid, as long as the nuclide is produced by irradiation with the particle beams B. However, in this embodiment, due to the configuration in which the source material body is transported by the cooling water W, the source material body other than solid is used in a state where source material body is housed in, for example, a disc-shaped case body.

Further, in this embodiment, even when the source material body is solid, the source material body is possibly housed in the case body, and the irradiation condition of the particle beams B to the source material body can be adjusted by the shape and size of the case body, the material, a gap between the source material body and the case body, and the like.

The target transport system 100 is provided in such a hot lab having an area closed by a radiation shielding material S. In FIG. 2, the side on which the target holding part 3 is arranged with the radiation shielding material S as a boundary is defined as an irradiation chamber H closed by the radiation shielding material S. The pump 9, a tank 6 for the cooling water W, and the target entry port 5 are arranged outside the irradiation chamber H. The target holding part 3, the target entry port 5, and the tank 6 are connected by the transport pipeline 1, and the transport pipeline 1 is connected to the inside and the outside of the irradiation chamber H through an underground pit G.

However, this embodiment is not limited to the above configuration. In the transport system of this embodiment, the target entry port 5 is necessarily installed in the hot cell, but a pump, a water tank, and valves do not necessarily have to be installed in a specific place such as the hot cell. The pump, the water tank, and the valves may be installed at suitable positions such as underground pits in terms of space allocation.

This embodiment further includes a heat exchanger 60 which is a cooling mechanism for cooling water (cooling water W) used for transporting the target body 50 by the transport mechanism 17. The heat exchanger 60 takes in a part of the cooling water W flowing through the transport pipeline 1 and brings the water into contact with a refrigerant to cool the water, and returns the cooled water to the transport pipeline 1.

In this embodiment, the heat exchanger 60 is provided inside the irradiation chamber H together with the target holding part 3. Hereinafter, the above configurations will be described in order.

### (Target Body)

The target body 50 may contain at least a source material body as a material for producing a nuclide, may contain a material other than the source material body, or may contain only a source material body. Further, the target body 50 may have a container (for example, a hollow metal container) for housing or supporting the source material body together with the source material body. In this embodiment, the target body 50 will be described as a source material body itself having a disc shape. The configuration of the target body having a container will be described later as a modification.

The examples of the source material body include ¹⁸O—H₂O, N₂, O₂, Ca, Cr, Fe, Ni, Zn, Ga, Ge, Se, Kr, Sr, Y, Mo, Cd, Te, Xe, W, Ir, Pt, Tl, Bi, Ra, and Th. Further, a solid material (Ca, Cr, Fe, Ni, Zn, Ga, Ge, Se, Sr, Y, Mo, Cd, Te, W, Ir, Pt, Tl, Bi, Ra, and Th) is preferable as the source material body.

### (Transport Pipeline)

The transport pipeline 1 can allow the cooling water W pumped from the tank 6 by the pump 9 to flow in a direction F1 from the target entry port 5 toward the target holding part 3. Further, the transport pipeline 1 can allow the cooling water W to flow in a direction F2 from the target holding part 3 toward the target entry port 5. The reversal of the flow direction of the cooling water W can be realized by reversing the rotation direction of the pump 9. Incidentally, in this embodiment, the target body 50 is transported through the transport pipeline 1 by the cooling water W, and thus, the flow direction of the cooling water W is hereinafter also referred to as a “transport direction”.

A plurality of valves 4a to 4f are provided in the transport pipeline 1. The valves 4a, 4b, 4c, and 4d are valves for switching the flow path of the cooling water W flowing through the transport pipeline 1 by a combination of opening and closing.

The pump 9 may be a pump such as a positive displacement reciprocating pump and a non-positive displacement centrifugal pump, and a pump having a capacity to pump the cooling water W of several liters to several hundred liters per minute is used. However, as the pump 9, a pump which does not cause pulsation or has a small pulsation is preferable. Examples of the pump having a small pulsation include a multiple reciprocating pump. The reason for using a pump 9 having a small pulsation is that, in this embodiment, the target body 50 is transported by the cooling water W, and thus, the pump 9 has a pulsation, this pulsation acts on the target body 50 to prevent the target body 50 from moving at a constant speed or standing still at the irradiation position.

The valves 4e and 4f are valves for switching the connection with an air introduction port, and air is introduced into the transport pipeline 1 by opening the valves 4e and 4f. Such valves 4e and 4f are opened when the cooling water W flowing through the transport pipeline 1 is dropped and the inside of the transport pipeline 1 is purged. The transport pipeline 1 is provided with pressure gauges 81 and 82 for measuring the pressure at which the cooling water W flows and a flow meter 7 for measuring the flow rate.

In this embodiment, each portion of the transport pipeline 1 is distinguished from a transport pipeline portion 1a to a transport pipeline portion 1k. The transport pipeline 1 is configured by a transport pipeline portion 1a between the valve 4f of the transport pipeline 1 and the target entry port 5, a transport pipeline portion 1b between the target entry port 5 and the target holding part 3, a transport pipeline portion 1c between the target holding part 3 and the valve 4e, a transport pipeline portion 1d between the valve 4e and the heat exchanger 60, a transport pipeline portion 1e between the valve 4e and the valve 4c, a transport pipeline portion if from the valve 4c to an end 1ff inserted into the tank 6, a transport pipeline portion 1g between the valve 4c and the valve 4a, a transport pipeline portion 1h between the valve 4a and the valve 4b, a transport pipeline portion 1j between the valve 4d and the valve 4f, a transport pipeline portion 1k between the valve 4d and an end 1aa, and a transport pipeline portion 1m between the heat exchanger 60 and the valve 4c.

The transport pipeline 1, the target entry port 5, and the pump 9 flow the cooling water W into the above-described transport pipeline 1 to transport the target body 50 to the target holding part 3. Further, the transport pipeline 1, the target entry port 5, and the pump 9 transport back the target body 50 from the target holding part 3 to the target entry port 5. The target body 50 reached to the target entry port 5 is taken out and recovered by a manipulator. As described above, in this embodiment, the cooling water W is flowed through the direction opposite to the transport direction when the target body 50 is recovered.

Specifically, in a case where the transport direction is set to the direction F1, that is, in a case where the target body 50 is transported from the target entry port 5 to the target holding part 3, the valves 4a and 4d are closed, and the valves 4b and 4c are opened. At this time, the cooling water W pumped up by the pump 9 passes through the transport pipeline portions 1h, 1a, 1b, 1c, 1d, 1e (partly a transport pipeline portion 1m) and if from the end 1ff to the tank 6. Further, in a case where the transport direction is set to the direction F2, that is, in a case where the target body 50 is recovered from to the target holding part 3 to the target entry port 5, the valves 4a and 4d are opened, and the valves 4b and 4c are closed. At this time, the cooling water W pumped up by the pump 9 flows from the end 1aa to the tank 6 through the transport pipeline portions 1g, 1e, 1d, 1c, 1b, 1a, 1j, and 1k.

The target body 50 moves in the transport direction while being immersed in the cooling water W described above. At this time, in this embodiment, the transport pipeline 1 is configured such that the target body 50 is not inverted front and back in the transport pipeline 1. Specifically, the target body 50 of this embodiment has a disc shape, and a maximum inner length of the transport pipeline 1 in a height direction orthogonal to a longitudinal direction and a width direction is smaller than the diameter of the disc shape of the target body 50. The front and back sides of the target may be, for example, based on the surface on the side to be irradiated with the particle beams B or based on one surface determined at the time of introduction into the target entry port 5.

That is, in order that the disc-shaped target body 50 rotates by 180 degrees (inverted front and back) with the central axis of the transport pipeline 1 as a rotation axis in the transport pipeline 1, the inner lengths of the transport pipeline 1 in the width direction and the height direction are necessarily equal to or larger than the diameter of the disc shape. In this embodiment, as long as the target body 50 moves in the transport pipeline 1, the inner length of the transport pipeline 1 in the width direction is equal to or larger than the diameter of the target body 50. Here, in this embodiment, when the inner length of the transport pipeline 1 in the height direction is shorter than the diameter of the target body 50, the target body 50 can be prevented from being inverted in the transport pipeline 1. Further, as a result, when the transport pipeline 1 of this embodiment is cut in the width direction, the cross section becomes a rectangular shape or an oval shape in which the length in the height direction is shorter than the length in the width direction.

### (Target Holding Part)

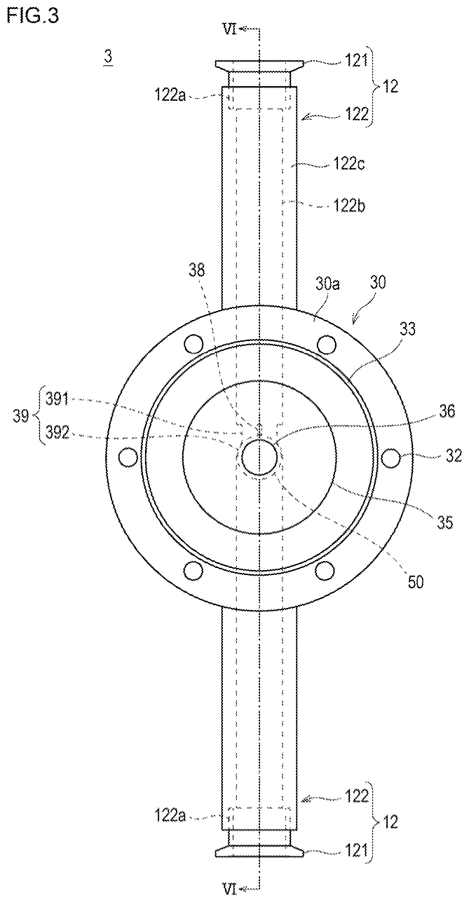

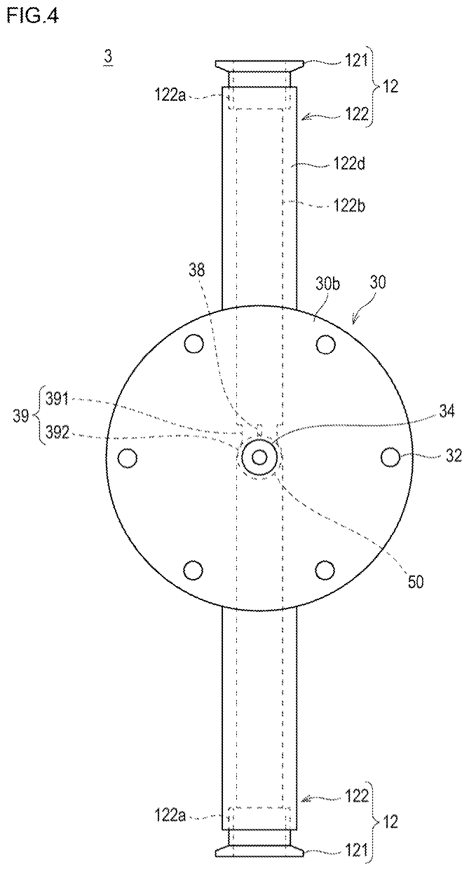

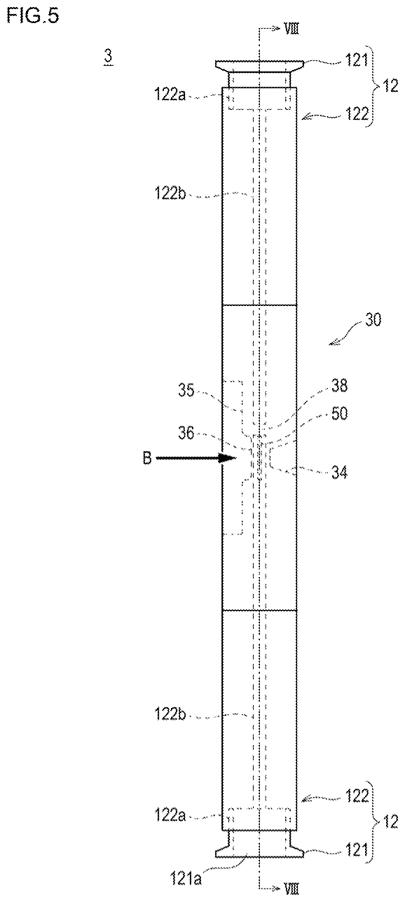

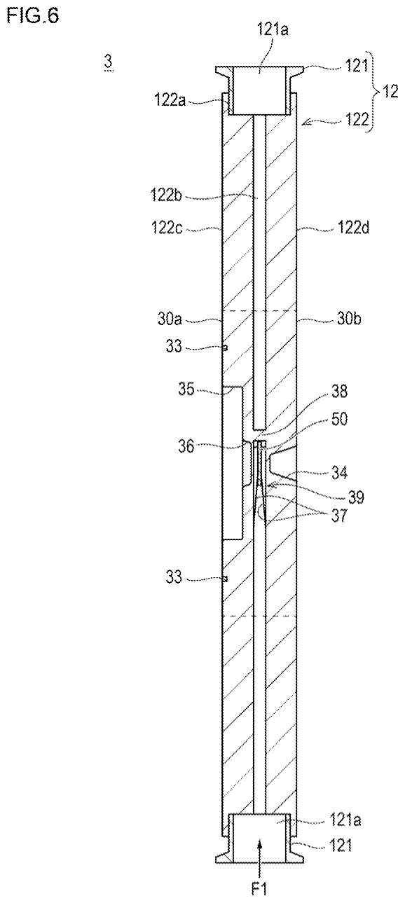

FIGS. 3 to 6 are diagrams for explaining the target holding part 3. Incidentally, in FIGS. 3 to 6, the side of the target holding part 3 to be irradiated with the particle beams B is referred to as an “upper surface”, and the opposite surface thereof is referred to as a “lower surface”. FIG. 3 is an upper surface side view of the target holding part 3, and FIG. 4 is a lower surface side view of the target holding part 3. FIG. 5 is a right side view of the target holding part 3 illustrated in FIG. 3, and FIG. 6 is a cross-sectional view when the cross section of the target holding part 3 cut along the one dot chain line illustrated in FIG. 3 is viewed in the direction of arrow VI-VI.

As illustrated in FIGS. 3 to 6, the target holding part 3 is configured by the irradiation flange 30 and the irradiation pipeline 12. As illustrated in FIG. 6, the irradiation flange 30 and the irradiation pipeline 12 are integrally configured. The irradiation pipeline 12 has a pipeline portion 122 and a joint portion 121. The target holding part 3 is configured by stacking and fixing two plate portions having parts (irradiation flanges 30) projecting in a semicircular shape in the direction orthogonal to the longitudinal direction at the middle of the longitudinal direction of the irradiation pipeline 12. The surface of the irradiation flange 30 on the side to be irradiated with the particle beams B is referred to as an upper surface 30a, and the back surface thereof is referred to as a lower surface 30b. Further, the surface of the pipeline portion 122 following the upper surface 30a is referred to as an upper surface 122c, and the surface of the pipeline portion 122 following the lower surface 30b is referred to as a lower surface 122d.

The pipeline portion 122 has a fitting groove 122a for fitting the joint portion 121 and an irradiation pipeline portion 122b communicating with the fitting groove 122a. The two ends of the irradiation pipeline portion 122b are connected to the transport pipeline portion 1c and the transport pipeline portion 1b by the joint portion 121, respectively. Further, the inside of the joint portion 121 serves as a gap 121a. With such a configuration, the transport pipeline portion 1c, the irradiation pipeline portion 122b, and the transport pipeline portion 1b communicate with each other, and the target body 50 can move back and forth between the transport pipeline portion 1b and the irradiation pipeline portion 122b.

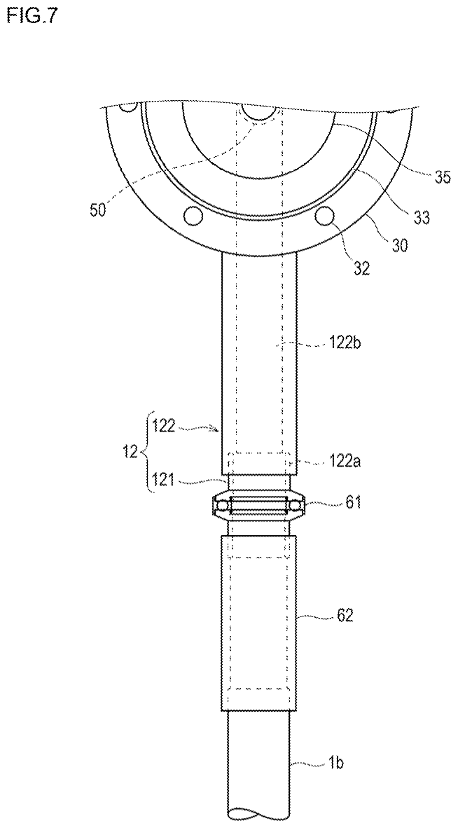

FIG. 7 is a diagram for explaining the connection between the pipeline portion 122 and the transport pipeline portion 1b illustrated in FIG. 3 and the like. As illustrated in FIG. 7, the fitting groove 122a is fitted into the pipeline portion 122 from the outside of the irradiation pipeline portion 122b. On the other hand, the transport pipeline portion 1b is fitted to one end of a joint 62, and the joint portion 121 is fitted to the other end of the joint 62. The joint portion 121 on the side of the irradiation pipeline 12 and the joint portion 121 on the side of the joint 62 are connected by a waterproof metal seal 61 to prevent water leakage between the irradiation pipeline 12 and the transport pipeline portion 1b.

The upper surface 30a has a circular groove 33, a circular recess 35 formed on the inner circumference of the circular groove 33, and a circular recess 36 formed inside the recess 35. The recess 36 is a circular recess of which the center point coincides with that of the circular recess 35 and of which the diameter is smaller than that of the recess 35. Flange bolts 32 provided at equal intervals on the outer circumference of the circular groove 33 screw the upper surface 30a and the lower surface 30b. The recess 36 is a portion to be irradiated with the particle beams B, and the target body 50 is held on the back surface of the recess 36.

A recess 34 is formed on the lower surface 30b. The recess 34 has a shape in which the diameter of the bottom surface is smaller than the opening diameter.

As illustrated in FIG. 6, the target body 50 is held in a part including the portion of the irradiation pipeline portion 122b sandwiched between the bottom surface of the recess 36 and the bottom surface of the recess 34. In this embodiment, the portion in which the target body 50 is positioned and which is sandwiched between the bottom surface of the recess 36 and the bottom surface of the recess 34 serves as the irradiation position of the particle beams B.

The portion holding the target body 50 has slopes 37 on the back surfaces of the upper surface 30a and the lower surface 30b such that the irradiation pipeline portion 122b narrows toward the direction F1. A regulation part 38 is formed at a portion where the target body 50 held between the slopes 37 abuts. The regulation part 38 and the slopes 37 serves as a part of a detention mechanism for holding the target body 50 in the irradiation pipeline portion 122b.

In the detention mechanism having the slopes 37, the target body 50 transported in the direction F1 is smoothly inserted and abuts on the regulation part 38. At this time, the cooling water W continues to flow in the direction F1, and thus the target body 50 is pressed against the regulation part 38 to regulate the rise and is fixed.

Next, the above detention mechanism will be described.

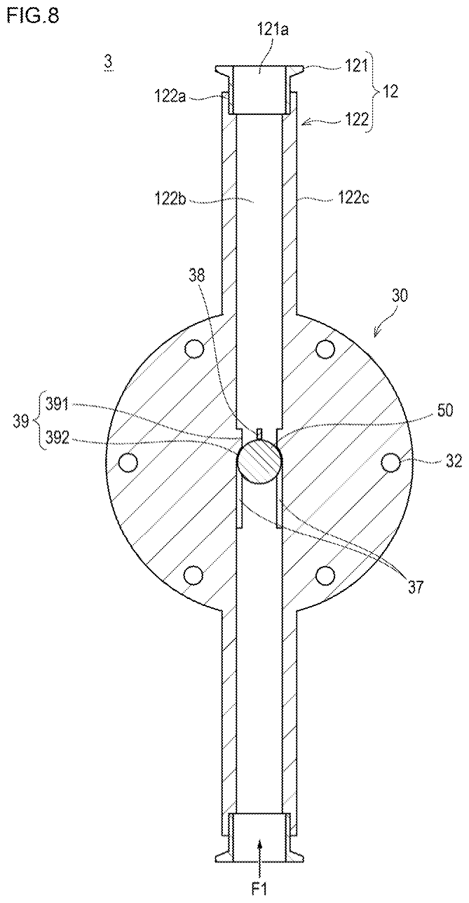

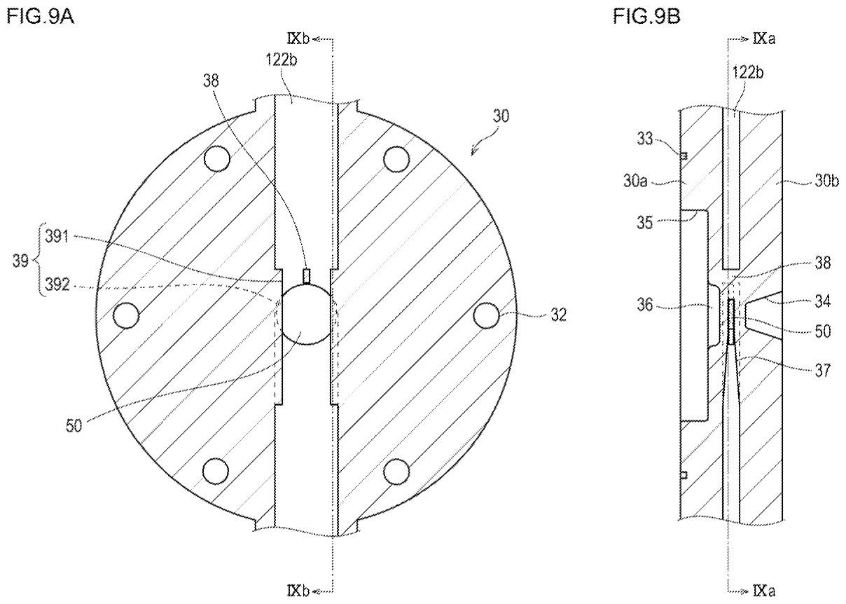

FIGS. 8, 9A, and 9B are diagrams for explaining the detention mechanism. FIG. 8 is a cross-sectional view when the cross section of the target holding part 3 cut along the one dot chain line illustrated in FIG. 5 is viewed in the direction of arrow VIII-VIII. FIG. 9B is a partially enlarged view of FIG. 6. FIG. 9A is a cross-sectional view when the cross section of the irradiation flange 30 cut along the one dot chain line illustrated in FIG. 9B is viewed in the direction of arrow IXb-IXb.

The target holding part 3 internally includes the irradiation pipeline 12 through which the cooling water W flows, and the detention mechanism for detaining the target body 50 at an irradiation position where the target body 50 is irradiated with particle beams. As described above, the transport pipeline 1 communicates with the irradiation pipeline 12 of the target holding part 3, and the detention mechanism includes the regulation part 38 that regulates the rise of the target body 50 in the irradiation pipeline 12 and protruding parts 39 that protrude from two facing sides of the inner wall of the irradiation pipeline 12 to the opposite sides. The target body 50 is loosely inserted into the target holding part 3 in a state where the detention mechanism supports the target body 50 by the regulation part 38 and two protruding parts 39. In this embodiment, the regulation part 38 and two protruding parts 39 configure the detention mechanism.

In the above embodiment, the target body 50 can be loosely supported from three directions in the target holding part 3. In such an embodiment, the target body 50 can be fixed by applying a force of urging the target body 50 to the regulation part 38 while the target body 50 is irradiated with the particle beams B. Further, in this embodiment, in a case where an abnormality occurs during the irradiation of the particle beams B, the urging force is eliminated, and the target body 50 can be quickly removed from the irradiation position.

The transport pipeline 1 and the pump 9 configuring the transport mechanism causes the cooling water W to flow from below to above in the gravity direction with respect to the detention mechanism during the transport of the target body 50 to the irradiation position and the irradiation with the particle beams B. In this embodiment, the target body 50 is urged to the regulation part 38 by the pressure of the cooling water W, and the target body 50 can be dropped from the irradiation position and removed by stopping the flow of the cooling water W.

Incidentally, the target holding part 3 illustrated in FIG. 8 is arranged such that the slope 37 rises from below to above in the gravity direction. When the target body 50 is transported to the irradiation position of the target holding part 3, the target body 50 is transported in the direction F1.

The effect of the above configuration on the transport of the target body 50 will be described more specifically.

As illustrated in FIGS. 8, 9A and 9B, two protruding parts 39 are rectangular parts which protrude inward from the inner wall in the irradiation pipeline portion 122b when the cross section is viewed from the side of the upper surface 30a. On the other hand, when viewed from the lower surface 30b side, the protruding part has a rectangular portion 391 which is a part of the rectangular shape and a notch portion 392 of which the end has a partial circular shape along the circumference of the target body 50. The upper surface of the notch portion 392 serves as the slope 37.

In a case where the target body 50 abuts on the partially circular portion of the slope 37, the regulation part 38 abuts on the target body 50 between two slopes 37. The target body 50 is supported by two protruding parts 39 and the regulation part 38 at three points. Further, since the cooling water W flows in the direction F1 in the irradiation pipeline portion 122b, the target body 50 receives an upward force, and the upward movement of the target body is regulated by the regulation part 38. The target body 50 is fixed at the irradiation position by the upward force and the regulation force of the regulation part 38.

According to such a target holding part 3, the target body 50 falls downward due to gravity after the irradiation is completed. Therefore, the holding is canceled when the target body 50 is recovered. Further, when the flow direction of the cooling water W is switched, and the cooling water W flows in the direction F2, the target body 50 is transported in the direction F2 while being immersed in the cooling water W.

Further, according to such a configuration, even in a case where the flow of the cooling water W is stopped due to some trouble, the holding of the target body 50 can be quickly canceled, and the target body 50 can be removed from the irradiation position. Therefore, in this embodiment, it is possible to prevent that when the cooling water W is not flowing, the particle beams B are irradiated on the target body 50 to generate a large amount of heat, and the transport pipeline 1 is melted and damaged.

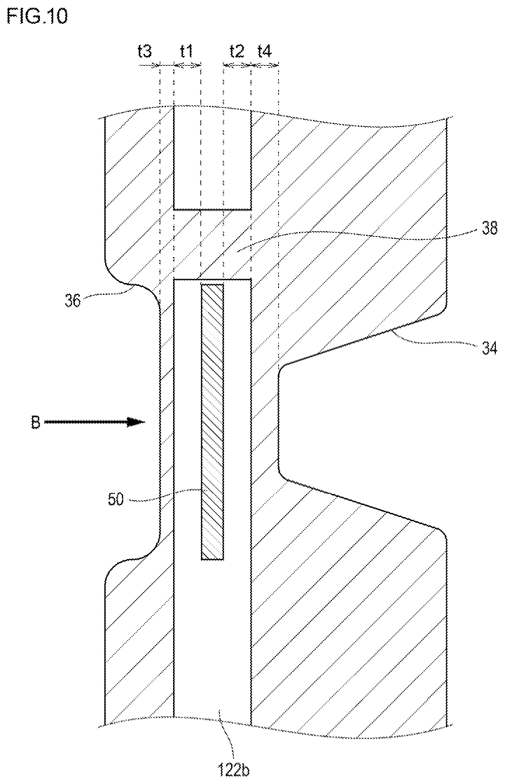

FIG. 10 is a diagram for explaining the position of the target body 50 during irradiation with the particle beams B. Incidentally, in FIG. 10, the protruding part 39 is not illustrated in order to clearly show the position of the target body 50.

The particle beams B are irradiated on the bottom surface of the recess 36. The inside of the irradiation pipeline portion 122b is filled with the cooling water W, and the irradiated particle beams B pass through the material of the target holding part 3 between the bottom surface of the recess 36 and the irradiation pipeline portion 122b to be irradiated on the upper surface of the target body 50. The irradiated particle beams B stop in the cooling water W on the side of the recess 34 of the target body 50. Incidentally, a plurality of metals can be candidates as the material of the target holding part 3, and for example, aluminum, stainless steel, titanium, niobium, and tantalum can be used.

As a condition suitable for the irradiation of the particle beam B described above, in this embodiment, the position of the target body 50 in the irradiation direction of the particle beam B in the irradiation pipeline portion 122b is set as follows.

That is, a thickness t1 illustrated in FIG. 10 is the distance between the upper surface of the target body 50 on the side to be irradiated with the particle beam B and the surface of the irradiation pipeline portion 122b facing the upper surface. A thickness t2 is the distance between the lower surface of the target body 50 with respect to the upper surface and the surface of the irradiation pipeline portion 122b facing the lower surface. The inside of the irradiation pipeline portion 122b is filled with the cooling water W, and the layers of the cooling water W having the thickness t1 and the thickness t2 are formed on the upper surface and the lower surface of the target body 50, respectively. A thickness t3 is the thickness of the material (for example, aluminum) from the bottom surface of the recess 36 of the target holding part 3 to the irradiation pipeline portion 122b, and a thickness t4 is the thickness of the material from the irradiation pipeline portion 122b to the bottom surface of the recess 34. The thicknesses t1, t2, t3 and t4 vary depending on the energy and type of particle beams. Incidentally, the target body 50 of this embodiment has a disc shape.

According to the above conditions, in a case where a malfunction (empty irradiation) of irradiating the particle beam B without the target body 50 occurs, heat is generated in the target holding part 3 on the side of the recess 34. In this embodiment, by providing a temperature sensor such as a thermoelectric pair on the side of the recess 34 and observing a temperature on the side of the recess 34, it is possible to detect the empty irradiation of the particle beam B and take an early action.

### (Target Transport Method)

The target transport system 100 described above includes an introduction process of introducing the target body 50 into the transport pipeline 1 through which the target body 50 containing at least a source material for producing a nuclide is transported, a transport process of transporting the introduced target body 50 to the target holding part 3 where the target body is irradiated with particle beams output from the accelerator 10 by a fluid flowing in the transport pipeline 1 and cooling the target body, a flow process of flowing the fluid in the transport direction of the target body 50 during the irradiation of the target body 50 with particle beams in the target holding part 3, and a recovery process of recovering the target body 50 from the transport pipeline 1 by the fluid after the irradiation of the target body 50 with particle beams in the target holding part 3 is completed.

That is, in the target transport system of this embodiment, an operator sets the target body 50 in the target entry port 5 by remote control using a manipulator. Further, after switching the valves 4a, 4b, 4c, 4d, and so on, the pump 9 is started to flow the cooling water W inside the transport pipeline 1. With such an operation, the target body 50 in the target entry port 5 is transported to the irradiation position of the target holding part 3. After the target body 50 reaches the irradiation position, the particle beams B are irradiated on the target body 50 for scheduled time.

After the irradiation with the particle beams B is completed, the operator inverts the flow direction of the cooling water W by the pump 9 and switches the valves 4a, 4b, 4c, 4d, and so on. With such an operation, a force in a direction of pressing the target body 50 against the regulation part 38 disappears. The target body 50 is detached from the protruding part 39 and is transported in the cooling water W toward the target entry port 5. The operator recovers the target body 50 by taking out the target body 50 reaching the target entry port 5 by using a manipulator.

In this embodiment described above, the target body 50 is transported to the target holding part 3 by the cooling water W flowing in the transport pipeline 1, so that the target body 50 can be transported by using the cooling mechanism essential for the target transport system. Therefore, it is advantageous to share the mechanism for circulating the cooling water W and the mechanism for transporting the target body 50 to downsize and simplify the configuration of the target transport system 100. Further, the mechanism for flowing the cooling water W can be realized without providing a configuration for mechanically and electronically driving near the target holding part 3, and thus it is possible to avoid the failure of the device due to adverse effects of radiation such as the failure of electronic components due to radiation and the deterioration of members. In such an embodiment, it is possible to realize the target transport system, the target body, and the target body transport method which are advantageous in simplifying and downsizing a configuration in production of RIs using the accelerator and in which components are hardly affected to be damaged by radiation.

Further, a fluid continues to flow in the transport direction of the target body during the irradiation of the target body with the particle beam in the target holding part, and thus the target body 50 can be continuously cooled during the irradiation with the particle beams at the same time as the irradiation with the particle beam is started.

However, this embodiment is not limited to using the cooling water W for cooling or transporting the target body 50. For example, a gas such as helium gas may be used as the fluid. Further, in this embodiment, it is conceivable to use a liquid metal (such as sodium and mercury) as a liquid other than water.

Further, this embodiment is not limited to a configuration in which the flow directions of the cooling water are opposite to each other in a case where the target body 50 is transported toward the target holding part 3 and a case where the target body 50 is transported toward the target entry port 5. In this embodiment, the cooling water W may be flowed in the same direction before and after the irradiation with the particle beams B to transport the target body 50 to the target holding part 3 or the target entry port 5. Incidentally, such a configuration can be realized by appropriately changing the configurations of the regulation part 38 and the protruding part 39 and the arrangement of the transport pipeline 1.

In a case where the flow direction of the cooling water W is not changed, for example, it is conceivable that the holding part of the target body 50 is configured to elastically hold the target body 50. In such a case, in the pump 9, the rotation speed may be higher, and the pressure applied to the target body 50 may be higher when the target body 50 is transported to the target entry port 5 as compared with a case where the target body 50 is transported to the target holding part 3. In such a case, during the irradiation with the particle beams B, the target body 50 is held by the holding part, and after the irradiation is completed, the target body is separated from the holding part and transported in the same direction as the transport direction before the irradiation. Incidentally, in the case of performing such an operation, it is preferable to use the pump 9 having a wide range of rotation speed changes.

The above-described embodiment and modification include the following technical ideas.

(1) A target transport system comprising: a transport pipeline through which a target body containing at least a source material body for producing a nuclide is transported; a target holding part that holds the target body and allows the target body to be irradiated with particle beams output from an accelerator; and a transport mechanism that transports the target body to the target holding part by a fluid flowing in the transport pipeline in a transport direction and concurrently cooling the target body, wherein the transport mechanism causes the fluid to flow in the transport pipeline in the transport direction during irradiation with the particle beams in the target holding part, and the target body is recovered by the fluid from the transport pipeline after the irradiation with the particle beams is completed.

(2) The target transport system according to (1), further comprising: a cooling mechanism that cools the fluid used for transporting the target body by the transport mechanism.

(3) The target transport system according to (1) or (2), wherein the transport mechanism causes the fluid to flow in a direction opposite to the transport direction when the target body is recovered.

(4) The target transport system according to any one of (1) to (3), wherein the target holding part internally includes an irradiation pipeline through which the fluid flows and a detention mechanism for detaining the target body at an irradiation position where the target body is irradiated with the particle beams, and the transport pipeline communicates with the irradiation pipeline, and

the detention mechanism includes a regulation part which regulates a rise of the target body in the irradiation pipeline and protruding parts which protrude from two facing sides of an inner wall of the irradiation pipeline to opposite sides, and the target body is loosely inserted into the target holding part in a state where the target body is supported by the regulation part and the two protruding parts.

(5) The target transport system according to (4), wherein the transport mechanism causes the fluid to flow from below to above in a gravity direction with respect to the detention mechanism during transport of the target body to the irradiation position and the irradiation with the particle beams.

(6) The target transport system according to any one of (1) to (5), wherein the target body has a disc shape, and a maximum inner length of the transport pipeline in a height direction orthogonal to a longitudinal direction and a width direction is smaller than a diameter of the disc shape.

(7) A target body used in the target transport system according to any one of (1) to (6), comprising: a first plate portion which is directed in an irradiation direction of particle beams; a second plate portion which is parallel to the first plate portion; and a source material body which is loosely inserted between the first plate portion and the second plate portion, wherein an interval between the first plate portion and the material body is wider than an interval between the second plate portion and the material body.

(8) A target transport method comprising: an introduction process of introducing a target body into a pipeline through which the target body containing at least a source material body for producing a nuclide is transported; a transport process of transporting the introduced target body to a target holding part where the target body is irradiated with particle beams output from an accelerator by a fluid flowing in the pipeline; a flow process of flowing the fluid in a transport direction of the target body during the irradiation of the target body with the particle beams in the target holding part; and a recovery process of recovering the target body from the pipeline by the fluid after the irradiation of the target body with the particle beams in the target holding part is completed.

(9) A target body which contains at least a source material body for producing a nuclide and is irradiated with particle beams, the target body comprising: a first plate portion which is directed in an irradiation direction of the particle beams; a second plate portion which is parallel to the first plate portion; and a material body which is loosely inserted between the first plate portion and the second plate portion, wherein an interval between the first plate portion and the material body is wider than an interval between the second plate portion and the material body.

This application claims the priority based on Japanese application Japanese Patent Application No. 2018-179260 filed on Sep. 25, 2018, the entire content of which is incorporated herein by reference.

### REFERENCE SIGNS LIST

1 Transport pipeline
1a-1k Transport pipeline portion
1ff, 1aa End
1g Transport pipeline portion
3 Target holding part
4a-4f Valve
5 Target entry port
6 Tank
7 Flow meter
9 Pump
10 Accelerator
12 Irradiation pipeline
17 Transport mechanism
30 Irradiation flange
30a, 122c Upper surface
30b, 122d Lower surface
32 Flange bolt
33 Circular groove
34, 35, 36 Recess
37 Slope
38 Regulation part
39 Protruding part
50 Target body
60 Heat exchanger
81, 82 Pressure gauge
100 Target transport system
121 Joint portion
121a Gap
122 Pipeline portion
122a Fitting groove
122b Irradiation pipeline portion
391 Rectangular portion
392 Notch portion
B Particle beam
F1, F2 Direction
G Underground pit
H Irradiation chamber
S Shielding member

1. A target transport system comprising:
a transport pipeline through which a target body containing at least a source material body for producing a nuclide is transported;
a target holding part that holds the target body and allows the target body to be irradiated with particle beams output from an accelerator; and
a transport mechanism that transports the target body to the target holding part by a fluid flowing in the transport pipeline in a transport direction and concurrently cooling the target body, wherein
the transport mechanism causes the fluid to flow in the transport pipeline in the transport direction during irradiation with the particle beams in the target holding part, and the target body is recovered by the fluid from the transport pipeline after the irradiation with the particle beams is completed.

2. The target transport system according to claim 1, further comprising:
a cooling mechanism that cools the fluid used for transporting the target body by the transport mechanism.

3. The target transport system according to claim 1, wherein
the transport mechanism causes the fluid to flow in a direction opposite to the transport direction when the target body is recovered.

4. The target transport system according to claim 1, wherein
the target holding part internally includes an irradiation pipeline through which the fluid flows and a detention mechanism for detaining the target body at an irradiation position where the target body is irradiated with the particle beams, and the transport pipeline communicates with the irradiation pipeline, and
the detention mechanism includes a regulation part which regulates a rise of the target body in the irradiation pipeline and protruding parts which protrude from two facing sides of an inner wall of the irradiation pipeline to opposite sides, and the target body is loosely inserted into the target holding part in a state where the target body is supported by the regulation part and the two protruding parts.

5. The target transport system according to claim 4, wherein
the transport mechanism causes the fluid to flow from below to above in a gravity direction with respect to the detention mechanism during transport of the target body to the irradiation position and the irradiation with the particle beams.

6. The target transport system according to claim 1, wherein
the target body has a disc shape, and
a maximum inner length of the transport pipeline in a height direction orthogonal to a longitudinal direction and a width direction is smaller than a diameter of the disc shape.

7. A target body used in the target transport system according to claim 1, comprising:
a first plate portion which is directed in an irradiation direction of particle beams;
a second plate portion which is parallel to the first plate portion; and
a source material body which is loosely inserted between the first plate portion and the second plate portion, wherein
an interval between the first plate portion and the source material body is wider than an interval between the second plate portion and the source material body.

8. A target transport method comprising:
an introduction process of introducing a target body into a pipeline through which the target body containing at least a source material body for producing a nuclide is transported;
a transport process of transporting the introduced target body to a target holding part where the target body is irradiated with particle beams output from an accelerator by a fluid flowing in the pipeline and concurrently cooling the target body;
a flow process of flowing the fluid in a transport direction of the target body during the irradiation of the target body with the particle beams in the target holding part; and
a recovery process of recovering the target body from the pipeline by the fluid after the irradiation of the target body with the particle beams in the target holding part is completed.
